(19) United States
(12) Patent Application Publication
(10) Pub. No.: US 2010/0104723 A1
(43) Pub. Date: Apr. 29, 2010

(54) Cookie Top Muffin

(76) Inventors: Michele Hale, Lighthouse Point, FL (US); Patricia Sabella, Coral Springs, FL (US)

Correspondence Address: ROBERT M. SCHWARTZ, P.A., P.O. BOX 221470, HOLLYWOOD, FL, 33022, US

(21) Appl. No.: 12/256,525

(22) Filed: Oct. 23, 2008

(51) Int. Cl. A21D 13/08; A21D 10/04

(52) U.S. Cl. 426/552

(57) ABSTRACT

The present invention is a two part baked cookie top muffin having a muffin lower portion and a cookie upper portion whereby the cookie top is fused to the muffin during baking.

### BRIEF SUMMARY OF THE INVENTION

### BRIEF DESCRIPTION OF THE DRAWINGS

FIG. 1 is a top view of the present invention.

FIG. 2 is a side view of the present invention.

FIG. 3 is a cross section view of the present invention.

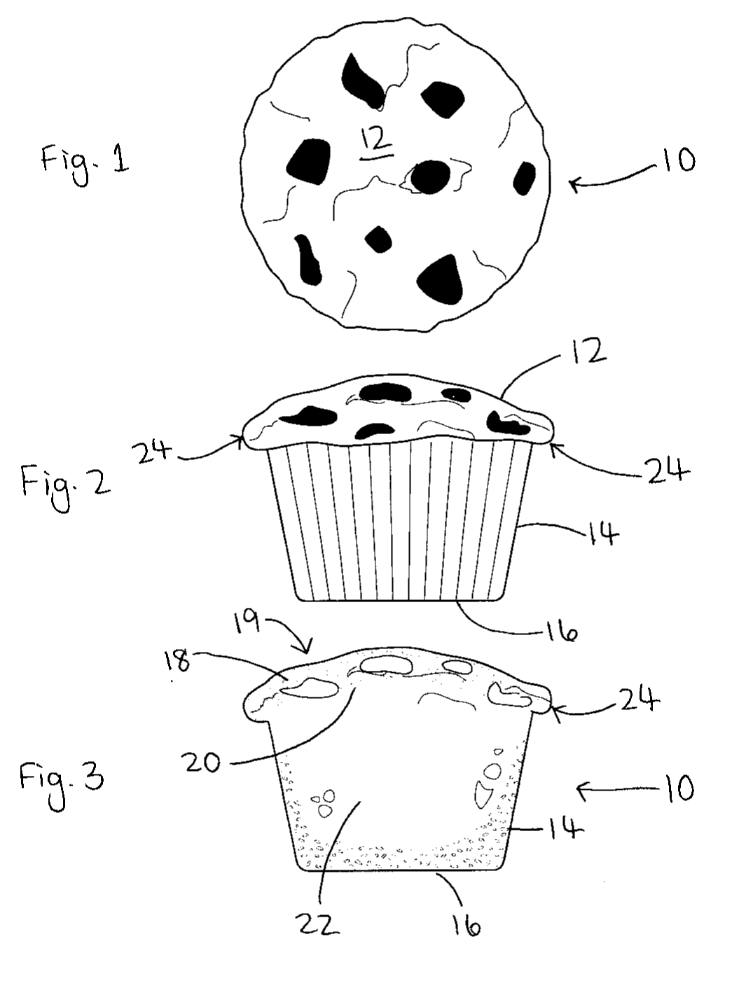

### DETAILED DESCRIPTION OF THE PREFERRED EMBODIMENTS

The present invention is cookie top muffin 10 that has cookie top 12 of cookie 19 and a muffin or cake portion 22. Cookie 19 and muffin 22 meet at interface 20. Muffin 22 has a base portion 16 and circumferal wall 14. Cookie 19 has circumferal edge 24 that is larger than the circumferal muffin wall portion 14 such that when cookie top 12 is positioned on muffin portion 20, circumferal edge 24 extends over circumferal wall 14.

The present invention is a cookie top muffin. Separate batters for a first portion comprising muffin batter and a second portion comprising cookie dough are prepared in order to produce cookie top muffin 10.

I. Cookie Dough

A cookie dough is prepared as follows:

Water, oil, and eggs are combined in a first mixing vessel. Flour, sugar and baking powder are combined in a second mixing vessel. The contents of the first mixing vessel are added to the second mixing vessel and the resultant mixture is blended until a cookie dough batter is formed.

II. Muffin Batter

A muffin batter is prepared as follows:

Water, oil, and eggs are combined in a first mixing vessel. Butter and/or margarine is melted and added to the first mixing vessel.

Flour, sugar and baking powder are combined in a second mixing vessel. The contents of the first mixing vessel are added to the second mixing vessel and the resultant mixture is blended until a muffin batter is formed.

III. Preparation of the Cookie Top Muffin

Muffin batter and cookie dough have different viscosities. In a preferred embodiment, they are prepared as follows:

Cookie Dough Ingredients

2 cups flour

½ tsp baking soda

½ tsp salt

¾ c unsalted butter, melted

1 cup packed brown sugar

½ cup white sugar

1 tbsp vanilla

2 eggs

2 cups chocolate chips

All ingredients are combined to produce a cookie dough.

Muffin Batter Ingredients

1 cup vital wheat gluten flour

½ cups flour

1½ tsp baking powder

¼ tsp salt

½ cup unsalted butter

¾ cup sugar

1½ tsp vanilla

2 eggs

¼ cup milk

¼ cup soybean oil

All dry ingredients are combined and mixed. Wet ingredients are added and mixed until a consistent batter is formed.

When muffins baked, they are baked at a temperature of 350° F. for approximately 20 minutes. When cookies are baked, they are baked at 325° F. for 15 min. The present invention addressed a need to arrive at an optimum cooking temperature and time for the cookie top muffin of the present invention. During an extensive testing process, it was found that when placing the raw cookie dough on top of the raw muffin batter, the cookie batter needs to be slightly pressed down to allow merging of the two batters. The muffin batter insulates the cookie dough therefore preventing it from cooking quicker than the muffin.

The combined dough/batter are cooked for 30 minutes at 325° F. The finished product is a perfectly formed cookie fused on top of a muffin.

Fusion of cookie 19 along interface 20 with muffin 22 is not a permanent fusion. Cookie 19 is releasably fused to muffin 22 along interface 20. Thus the bottom portion of cookie 19 in contact with interface 20 has a different hardness and consistency than cookie interior 18 and cookie top 12. As is known in the art, cookie top surface 12 typically has a slightly increased hardness than the interior of cookie 18. Also, as is known, the bottom surface of baked cookies can become undesirably hard when baked directly on a cookie sheet. Because cookie 18 is insulated at interface 20, there is a reduced likelihood that the lower portion of cookie 19 will be overcooked.

While the invention has been described in its preferred form or embodiment with some degree of particularity, it is understood that this description has been given only by way of example and that numerous changes in the details of construction, fabrication, and use, including the combination and arrangement of parts, may be made without departing from the spirit and scope of the invention.

I claim:

1. A baked article comprising:
a. a first portion formed of baked muffin batter;
b. a second portion disposed on said first portion formed of cookie dough;
wherein said first portion and second portion are releasably attached at their interface.

2. The baked article of claim 1 wherein said second portion fuses to said first portion during baking.

3. The baked article of claim 1 wherein said second portion substantially covers the top surface of said first portion.

4. The baked article of claim 1 wherein the periphery of said second portion extends beyond the periphery of said first portion.

5. A method of preparing a baked article having a first and second portion comprising:
a. preparing a first portion comprising muffin batter;
b. preparing a second portion comprising cookie dough;
c. placing said first portion inside a baking dish;
d. covering said placed first portion with said second portion, creating an interface between the upper surface of said first portion and a lower surface of said second portion;
e. insulating said lower surface of said second portion wherein said interface between said first portion and said second portion insulates the lower surface of said second portion to prevent overcooking of said second portion;
f. placing said article in an oven for baking said first portion with said second portion disposed thereon;
g. fusing said lower portion of said second portion to said upper surface of said first portion;
h. removing a finished article from said oven;
i. allowing said article to cool.
